(19) United States
(12) Patent Application Publication
(10) Pub. No.: US 2015/0330424 A1
(43) Pub. Date: Nov. 19, 2015

(54) FRICTIONALLY ENGAGED FASTENING OF A FIRST COMPONENT TO A SECOND COMPONENT

(71) Applicant: GM GLOBAL TECHNOLOGY OPERATIONS LLC, Detroit, MI (US)

(72) Inventors: Uwe ARZ, Weiterstadt (DE); Thomas MARX, Eschborn (DE)

(73) Assignee: GM GLOBAL TECHNOLOGY OPERATIONS LLC, Detroit, MI (US)

(21) Appl. No.: 14/711,344

(22) Filed: May 13, 2015

(30) Foreign Application Priority Data
May 15, 2014 (DE) 102014007103.0

(51) Int. Cl. F16B 2/02

(52) U.S. Cl. CPC F16B 2/02

(57) ABSTRACT

A method for the frictionally-engaged fastening of a first component to a second component is disclosed. A prefabricated carrier is arranged on a first face of the first component. A second face of the second component is subsequently clamped against to the first face, while the prefabricated carrier is arranged therebetween. The prefabricated carrier has particles arranged on and/or embedded therein in order to increase a friction coefficient between the first and second component.

### CROSS-REFERENCE TO RELATED APPLICATION

This application claims priority to German Patent Application No. 102014007103.0, filed May 15, 2014, which is incorporated herein by reference in its entirety.

### TECHNICAL FIELD

The present disclosure relates to a method for frictionally-engaged fastening of a first component to a second component, an arrangement with a first component that is fastened to a second component in a frictionally engaged manner, and to a method for prefabricating a carrier of such an arrangement.

### BACKGROUND

DE 10 2012 212 295 A1 discloses a method for creating a connection which transmits a rotational moment between a shaft and a bore, in which an incompressible friction varnish with boron carbide powder hardens on the shaft or bore.

### SUMMARY

In accordance with the present disclosure an advantageous arrangement is disclosed having a first component fastened to a second component in a frictionally engaged manner. According to an aspect of the present disclosure, the arrangement includes a first component and a second component, to which the first component is fastened in a frictionally engaged manner. The first component can be a shaft which is fastened in a bore of the second component in a frictionally engaged manner. Conversely, the second component can equally be a shaft in an embodiment which is fastened in a bore of the first component in a frictionally engaged manner. Equally, the first component in an embodiment can be arranged on the second component or the second component on the first component and fastened to the same in a frictionally engaged manner.

According to an aspect of the present disclosure, a substrate or carrier is prefabricated with particles arranged in an adhering or fixed manner. The prefabricated carrier is arranged on a first face of the first component. A second component is clamped to the first component such that a second face of the second component covers the first face of the first component while the prefabricated carrier is arranged therebetween. The particles arranged in the prefabricated carrier increase a friction coefficient between the first and second component. By using a prefabricated carrier, the assembly and/or disassembly of the arrangement and/or the characteristics and/or the production of the friction-increasing layer between the first and second faces can be improved compared with an application and hardening of a friction coating. Additionally or alternatively it is advantageously possible in an embodiment to reuse the prefabricated carrier.

In an embodiment, at least 25%, preferably at least 50%, and more preferably at least 75% of the particles have a minimal diameter that is greater than a wall thickness of the carrier when compressed between the first and second faces. In a further development, at least 25%, preferably at least 50%, and more preferably at least 75% of the particles have a minimal diameter that is greater than a wall thickness of the carrier not yet compressed between the first and second faces in the position of the particles. In this way, the particles in an embodiment reliably enter both the first and also the second face when the prefabricated carrier is arranged between the first and second faces clamped together. In an embodiment, the carrier that is arranged between the first and second faces clamped together is elastically or plastically compressed.

In various embodiments the first and second faces are detachably secured together in a clamping manner. As used herein “clamping” when referring to the first and second faces means applying a normal force or stress F_{N} perpendicularly or normally relative to the first and/or second face which imparts a maximum friction force or stress F_{R} between the first and second body parallel to this face, which is determined or limited by a static friction coefficient μ₍₀₎. (F_{R}≦μ₍₀₎·F_{N}). As used herein a rotational moment is also referred to as a force in a generalizing manner. Such a normal force or stress can in particular be applied in particular through screwing together the first and second component, through shrinking the first component onto the second component and/or expanding the second component into the first component, or by shrinking the second component onto the first component and/or expanding the first component into the second component. As used herein, “shrinking-on” is to mean assembling a fit enlarged through heating with subsequent cooling down again and “expanding-in” is to mean assembling a fit enlarged through cooling down with subsequent re-heating.

In an embodiment, the first and second faces are detachably clamped together in particular by threaded fasteners. In this way, the arrangement can be advantageously easily disassembled when required. In another embodiment, the first and second faces are permanently clamped together in particular through shrinking-on and/or expanding-in. In this way, a simple, more compact and/or more reliable connection can be made available in an embodiment. In particular, when the first and second faces are clamped to one another through screwing together, the first and second faces can be flat in an embodiment. In particular when the first and second faces are clamped together through shrinking-on and/or expanding-in, the first and second faces in an embodiment can be curved, in particular cylindrical or conical.

In an embodiment, the carrier is fastened to the first and/or second face(s) in a positively and/or materially joined manner. The carrier, in an embodiment, in particular before or after contacting the second face, can be bonded to the first face. Additionally or alternatively, the carrier, in an embodiment, can be fastened to the first and/or second face(s) in a positively joined manner, in particular inserted in a corresponding depression in the first or second component or abut a stop on the first or second component. In this way, the assembly and/or connection of the carrier can be improved in an embodiment.

In an embodiment, at least 10% of the particles, preferably at least 50%, and more preferably at least 75% of the particles include a mineral, in particular corundum (Al₂O₃), in particular synthetically produced corundum, for example by means of the melting, dripping or Verneuil process or electro-melting method, in particular regular corundum (96% Al₂O₃) or refined corundum (99.7% Al₂O₃). In an embodiment, at least 10% of the particles, preferably at least 50%, and more preferably at least 75% of the particles consist thereof. In this way, a cost-effective and/or significant friction value increase can be achieved in an embodiment. In an embodiment, the particles are hard material particles with a Mohs scale hardness in the range of 6 to 9.5, and preferably having a maximum of 9. In this way, advantageous micro-interlocking of the particles with the first and/or second component can be achieved in an embodiment. In an embodiment, the first and/or second face(s) is made of steel, cast iron, an aluminum alloy, a magnesium alloy or another metallic material.

In an embodiment, the carrier not yet compressed between the first and second faces has a wall thickness of at least 50 μm and preferably at least 0.9 mm, and/or a maximum of 10 mm, and preferably a maximum of 2.5 mm. In this way, the handling ability of the carrier can be improved in an embodiment.

In an embodiment, the carrier includes plastic and preferably a thermoplastic. The thermoplastic may be acrylonitrile-butadiene-styrene (ABS), polyamide (PA), polylactide (PLA), polymethylmethacrylat (PMMA), polycarbonate (PC), polyethylene terephthalate (PET), polyethylene (PE), polypropylene (PP), polystyrene (PS), polyetheretherketon (PEEK) or polyvinyl chloride (PVC). In this way, the production and/or handleability of the carrier can be improved in an embodiment.

According to an aspect of the present disclosure, the carrier is prefabricated from a thermal plastic through extrusion and subsequent equipping of the thermoplastic having a temperature of more than 310 K with the particles. Through extruding, in particular blow film extruding, a carrier with an advantageous wall thickness can be produced in a simple, cost-effective manner in particular as a semi-finished product which is subsequently trimmed. In an advantageous further development, the thermoplastic still heated from extruding to at least 310 K is equipped with the particles which join up with the thermoplastic during cooling down.

According to another aspect of the present disclosure, the carrier is prefabricated by varnishing a peel-off face, equipping the not yet hardened varnish with the particles and detaching the hardened varnish from the peel-off face. In contrast to applying and hardening of varnish on the components to be fastened in a frictionally engaged manner themselves, the present disclosure provides an assembly of the arrangement which is improved, in particular by shortening assembly time.

In an embodiment, at least 50% of the particles are embedded on a face of the carrier not yet compressed between the first and second faces. In a further development, at least 95% of the particles and preferably substantially all or the particles are embedded on a surface of the carrier not yet compressed between the first and second faces. Because of this, the equipping of the carrier can be simplified in an embodiment. In another further development, at least 50% of the particles are embedded on a surface and at least 25% of the particles are located on a surface opposite the former of the carrier not yet compressed between the first and second faces. In this way, interlocking with the first and second faces can be improved in an embodiment.

In an embodiment, the particles, with the prefabricated carrier or during the prefabricating of the carrier, are fastened to the carrier or arranged on the carrier in an adhering manner. In an embodiment, the particles adhere through in particular mechanical adhesion between the particles and the carrier, and/or through an adhesive between the particles and the carrier.

In an embodiment, a friction coefficient between the first and second components with the carrier arranged between the first and second faces clamped together becomes or is at least 10% and preferably at least 25% greater than a friction coefficient between the first and second faces clamped with the same surface pressure without carrier arranged between these. As explained above, the friction coefficient μ, in particular the static friction coefficient μ₀, determines the friction force or stress. In the embodiment, carrier and particles are selected and prefabricated in such a manner that a maximum transferable force between the first and second component with carrier arranged between the first and second faces clamped together is at least 10%, and preferably at least 25% greater than this maximum force with first and second faces clamped together without carrier arranged between these, when in each case the same normal force or stress is applied.

### BRIEF DESCRIPTION OF THE DRAWINGS

The present disclosure will hereinafter be described in conjunction with the following drawing figures, wherein like numerals denote like elements.

FIG. 1 illustrates a method for prefabricating a carrier of an arrangement shown in FIG. 4 according to on embodiment of the present disclosure;

FIG. 2 illustrates a method for prefabricating a carrier of the arrangement of FIG. 4 according to another embodiment of the present disclosure;

FIG. 3 illustrates a method for the frictionally engaged fastening of a first component to a second component of the arrangement of FIG. 4; and

FIG. 4 illustrates an arrangement according to an embodiment of the present disclosure.

In the figures, features corresponding to one another are identified by identical reference characters.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

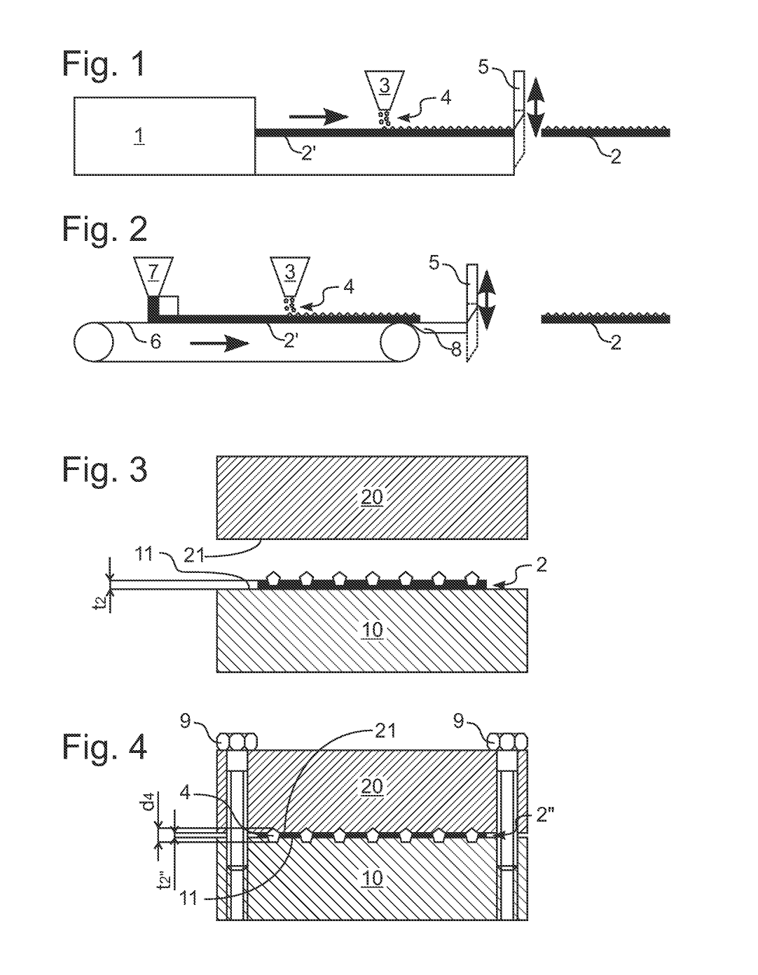

FIG. 1 shows a method for prefabricating a carrier 2 of an arrangement of FIG. 4 according to an embodiment of the present disclosure.

To this end, the carrier is extruded by an extruder 1 from a plastic, preferably a thermoplastic initially as a semi-finished product 2′, and in the still warm state having a temperature preferably of more than 310 K. The semi-finished product 2′ is equipped by an hopper or similar device 3 with particles 4 of industrial corundum. As shown in FIG. 1, the particles 4 are embedded on the upper surface of the semi-finished product 2′ where they adhere during the cooling down of the carrier. Following this, the semi-finished product 2′ with the particles 4 adheringly arranged thereon is cut to form the prefabricated carrier 2 by a blanking or shearing device 5.

FIG. 2 shows a method for prefabricating a carrier 2 of an arrangement of FIG. 4 according to another embodiment of the present disclosure. To this end, varnish is initially spread out on a peel-off surface 6 by a applicator 7 and this semi-finished product 2′ in the form of the not yet fully hardened varnish layer equipped by a hopper or similar device 3 with particles 4 of industrial corundum. As shown in FIG. 2, the particles 4 are embedded on the upper surface of the semi-finished product 2′ where they adhere during the hardening of the varnish layer. Following this, the hardened varnish 2′ is detached from the peel-off surface 6 by a separator 8 and cut to form the prefabricated carrier 2 by a blanking or shearing device 5.

The figure sequence from FIG. 3 to FIG. 4 shows a method for the frictionally-engaged fastening of a first face 11 of the first component 10 to a second face 21 of a second component 20 according to an embodiment of the present disclosure. As shown in FIG. 3, a prefabricated carrier 2, on which the particles 4 are arranged in order to increase a friction coefficient between the first and second faces 11, 21, is initially arranged on the first face 11 of the first component 10. The prefabricated carrier 2 can be in particular the carrier explained above with reference to FIG. 1 or 2. Following this, the first face 11 of the first component 10 and the second face 21 of the second component 20 are clamped together while the prefabricated carrier 2 is arranged between the first and second faces 11, 21 and in the process elastically or plastically compressed. The carrier 2″ that is compressed between the first and second faces 11, 21.

At least 25% of the particles 4 have a minimum diameter d₄, that is greater than a wall thickness t₂ of the carrier 2 not yet compressed between the first and second faces 11, 21 in the position of the particles and thus greater than a wall thickness t_{2″} of the carrier 2″ compressed between the first and second faces 11, 21.

In the exemplary embodiment of FIG. 4, the first and second faces 11, 21 are detachably clamped together by threaded fasteners 9. In a modification (not shown), the first and second faces 11, 21 are clamped together through shrinking-on and/or expanding-in. In the exemplary embodiment of FIG. 4, the first and second faces 1, 21 are flat. In a modification (not shown) the first and second faces 11, 21 are curved, in particular cylindrical or conical.

The prefabricated carrier 2 can be fastened to the first and/or second face(s) in a positively and/or materially joined manner. In particular, the carrier 2 before or after the clamping of the first and second faces 11, 21 can be bonded to the first face 11 in order to fix it on the same. Additionally or alternatively, it can be bonded to the second face 21 during or after the clamping together.

With the arrangement of FIG. 4, a friction coefficient μ₀ between the first and second body 10, 20, which is obtained from the quotient F_{R}/F_{N} of the maximally transmittable force F_{R} perpendicularly to the screw axis divided by the clamping force F_{N} of the screw connection 9, is increased by at least 10% compared with an identically designed arrangement clamped with the same clamping force without carrier 2 and particles 4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A method for frictionally-engaged fastening of a first component to a second component comprising:
arranging a carrier on a first face of the first component, wherein the carrier includes a substrate having a plurality of particles arranged therein for increasing a friction coefficient of the carrier; and
subsequently clamping the first face of the first component and a second face of the second component together such that the carrier is compressed therebetween.

17. The method according to claim 16, wherein at least 25% of the plurality of particles have a minimal diameter that is greater than a wall thickness of the substrate in a compressed state.

18. The method according to claim 16, wherein at least 25% of the plurality of particles have a minimal diameter that is greater than a wall thickness of the substrate in an uncompressed state.

19. The method according to claim 16, further comprising detachably clamping the first and second faces together with a threaded fastener.

20. The method according to claim 16, further comprising durably clamping the first and second faces together by at least one of a shrinking-on or expanding-in process.

21. The method according to claim 16, wherein at least one of the first and second faces comprise a flat surface.

22. The method according to claim 16, wherein at least one of the first and second faces comprise a curved surface.

23. The method according to claim 16, further comprising fastening the carrier to at least one of the first and second faces in a positively joined manner.

24. The method according to claim 23, further comprising fastening the carrier to at least one of the first and second faces in a materially joined manner.

25. The method according to claim 16, wherein the particles comprise at least 10% a corundum (Al₂O₃) material.

26. The method according to claim 16, wherein the carrier comprises a plastic substrate having a wall thickness in the range of 50 μm-10 mm in an uncompressed state.

27. The method according to claim 26, wherein the method further comprises extruding a thermoplastic substrate and depositing the particles onto the substrate having a temperature of at least 310 K.

28. The method according to claim 16, wherein the method further comprises varnishing a peel-off surface to form the substrate, depositing the particles onto a not-yet-hardened substrate, hardening the substrate and detaching the hardened substrate from the peel-off surface.

29. The method according to claim 16, wherein at least 50% of the plurality of particles are embedded in the uncompressed substrate.

30. The method according to claim 16, wherein subsequently clamping the first and second components increases a coefficient of friction between the first and second faces by at least 10% when compared to a friction coefficient between the first and second faces clamped together without the carrier arranged therebetween.

31. An arrangement comprising a first component and a second component to which the first component is fastened in a frictionally-engaged manner in the method according to claim 16.
